(19) United States
(12) Patent Application Publication
(10) Pub. No.: US 2023/0129355 A1
(43) Pub. Date: Apr. 27, 2023

(54) PRINTING WITH DIFFERENT TYPES OF MASKS

(71) Applicant: HEWLETT-PACKARD DEVELOPMENT COMPANY, L.P., Spring, TX (US)

(72) Inventors: Javier Maestro Garcia, Sant Cugat del Valles (ES); Pau Costal Fornells, Sant Cugat del Valles (ES); Peter Morovic, Sant Cugat del Valles (ES); Sergio Etchebehere Juan, Sant Cugat del Valles (ES); Pere Josep Canti Nicolas, Sant Cugat del Valles (ES)

(21) Appl. No.: 17/452,141

(22) Filed: Oct. 25, 2021

(51) Int. Cl. G06F 3/12; H04N 1/52; H04N 1/60; G06K 15/10

(52) U.S. Cl. CPC G06F 3/1208; H04N 1/52; H04N 1/603; G06K 15/102; G06F 3/1254; G06F 3/1284

(57) ABSTRACT

In some examples, a system receives image data for printing by a printer, and for a given colorant of a plurality of colorants to be used to print an image based on the image data, selects a plurality of different types of masks to use when dispensing printing fluid drops of the given colorant when printing the image. The system generates control data for printing the image using the selected plurality of different types of masks.

### BACKGROUND

A printer is capable of forming an image onto a print medium, such as a paper medium, a plastic medium, and so forth. A printer can form an image on a print medium by dispensing a printing fluid onto selected portions of the print medium. For color printing, a printer can dispense printing fluids of different colors onto a print medium to form a color image.

### BRIEF DESCRIPTION OF THE DRAWINGS

Some implementations of the present disclosure are described with respect to the following figures.

FIG. 1 is a block diagram of a printer according to some examples.

FIGS. 2A-2B are graphs illustrating different types of masks according to some examples.

FIG. 3 is a block diagram illustrating the generation of an NPac vector that uses different types of masks as part of generating control data for printing an image, in the course of some examples.

FIG. 4 is a block diagram of a storage medium storing machine-readable instructions according to some examples.

FIG. 5 is a block diagram of a printer according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some printers, printing masks (or more simply, “masks”) can be used to control a frequency of activation of nozzles in an array of nozzles of a printhead. The nozzles of the printhead include orifices through which printing fluid drops are dispensed as nozzles are activated. Each nozzle is associated with a fluidic actuator (e.g., a resistive heater, a deflectable membrane such as a piezoelectric membrane, etc.) that when activated causes a quantity of a printing fluid drops (one drop or multiple drops) to be ejected through the orifice of the nozzle.

Properties of masks can affect output quality of an image produced by a printer, since the masks affect a distribution of printing fluid drops, both spatially and temporally. A printer can employ multiple passes when printing an image. The structures of masks used in a multi-pass print mode can affect how subsequent passes will interact with one other. The interaction of multiple passes over the same region of an image on a print medium can produce banding defects, especially in cases where printing fluids are sensitive to drying times between passes.

An example of a banding defect is Dark-Light Zone Banding (DLZB), which is a smooth banding that appears in multi-pass print modes due to changing print medium conditions as the passes progress (e.g., a printing fluid in a first pass lands directly on a dry print medium while a printing fluid in a last pass lands on top of all the printing fluids deposited in previous passes).

The banding issue may be exacerbated in printers that employ relatively complex inks or use extra fluids (e.g., an optimizer) to prepare a print medium for color printing fluids. The interactions between subsequent layers of printing fluids and an optimizer may be sensitive to time and printing fluid volume, as an output image may change substantially depending on how dry a previous layer is when the next layer of printing fluid is deposited. The use of complex inks and/or extra fluids can complicate the selection of a masking strategy that provides an optimal output for all colors.

The shapes of some types of masks can allow for a relatively smooth pass-to-pass interaction to reduce the banding effect. However, these types of masks may be constrained in other aspects such as firing (activation) frequency of printhead nozzles, and thus these types of masks may not be suitable for images with high density colors.

In accordance with some implementations of the present disclosure, techniques or mechanisms are provided to allow for use of an arbitrary mix of different types of masks for each colorant used in printing an image based on input image data. Techniques or mechanisms according to some implementations of the present disclosure provide the ability to use any combination of the different types of masks, which are selectable on a colorant-by-colorant basis. By being able to use different types of masks, printing strategies are not constrained by shortcomings of any single type of mask.

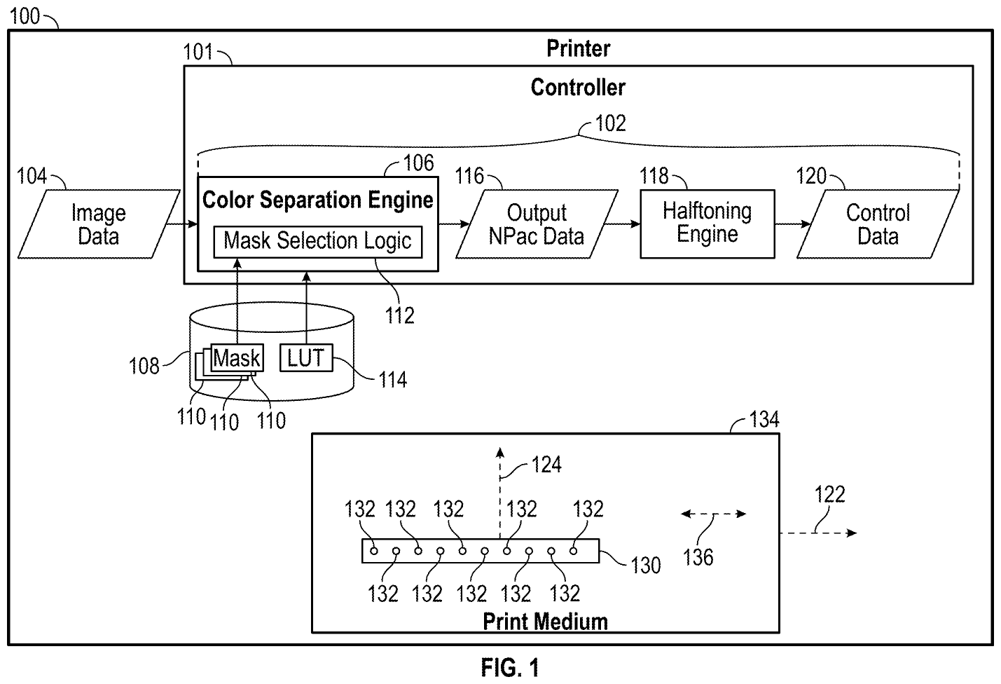

FIG. 1 is a block diagram of a printer 100 according to some examples. The printer 100 includes a printing pipeline 102, a printhead 130 that includes an array of nozzles 132, and a print medium 134 onto which printing fluids can be ejected from the nozzles 132 that are actuated.

The printer 100 can be a two-dimensional (2D) printer that prints images onto the print medium 134, such as a paper, a plastic foil, a cloth substrate, and so forth. In other examples, techniques or mechanisms according to some implementations of the present disclosure can be applied with a three-dimensional (3D) printer, in which printing fluids can be dispensed onto targets in the form of 3D parts for the purpose of forming a 3D object. In a 3D printer, a 3D object is built on a layer-by-layer basis, in which layers of build material are provided onto a print bed, followed by dispensing of printing fluids onto each successive build material layer for defining portions of the 3D object.

The printing pipeline 102 can be part of a printer controller (or more simply a “controller”) 101 in the printer 100. In other examples, the printing pipeline 102 can be implemented in a computer separate from the printer 100. In some examples, the printing pipeline 102 includes a Halftone Area Neugebauer Separation (HANS) pipeline.

The printing pipeline 102 generates control data 120 to control printing an image on the print medium 134. The printing pipeline 102 receives input image data 104 that is passed to a color separation engine 106. The image data 104 may include color data represented in an image color space, such as image-level pixel representations in a red-green-blue (RGB) color space, a cyan-magenta-yellow-black (CMYK) color space, and so forth.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit. The engine can include a portion of the hardware processing circuit of the controller 101, or alternatively, the engine can include machine-readable instructions executable by the controller 101.

The color separation engine 106 maps the color data from the image color space to an intermediate color space. In some examples, the intermediate color space includes an area coverage space, for example a Neugebauer Primary area coverage (NPac) color space. An element in the NPac color space is a vector (referred to as an “NPac vector”) that represents a statistical distribution of Neugebauer Primaries (NPs) over a given area of a halftone. NPacs represent the linear convex combinations of NPs. Each component of an NPac vector defines the probability of choosing a respective NP. For example, an NPac vector can define the following probabilities for respective NPs: 1/9 for W (blank or white in an example where the print target is white); 0 for C (cyan); 2/9 for M (magenta); 0 for Y (yellow); 3/9 for CM (a combination of cyan and magenta); 1/9 for CY (a combination of cyan and yellow); 1/9 for MY (a combination of magenta and yellow); 1/9 for CMY (a combination of cyan, magenta, and yellow).

An NP is a combination of colorants available to a printer for reproducing colors that may have been received in a different color space and which have been mapped into the NPac color space. Each element of an NP may specify a quantity of a respective colorant for the associated pixel in the colorant color space. In a simple binary (bi-level, i.e., two drop states: “drop” or “no drop”) printer, an NP may be one of 2^{k}−1 combinations of k printing fluids within the printer, or an absence of printing fluid (resulting in 2^{k} NPs in total). A colorant or printing fluid combination as may be formed of one or multiple colorants or printing fluids such as ink. For example, if a bi-level printer uses CMY printing fluids, there can be eight NPs. These NPs relate to the following: C, M, Y, CM, CY, MY, CMY, and W (white or blank indicating an absence of printing fluid). An NP may include an overprint of two available printing fluids, such as a drop of magenta on a drop of cyan (for a bi-level printing system) in a common addressable print area (e.g. a printable “pixel”). An NP may be referred to as a “pixel state”.

In multi-level printers, e.g., including printheads that are able to deposit N (N>1) drop levels, an NP may include one of N^{k}−1 combinations of k printing fluids, or an absence of printing fluid (resulting in N^{k} NPs in total). For example, if a multi-level printer uses CMY printing fluids with four different drop states (“no drop”, “one drop”, “two drops” or “three drops”), a total of 64 NPs, including for example C, CM, CMM, CMMM.

Typically, halftone levels are used to define a quantity of drops of a colorant in an NP. However, in accordance with some implementations of the present disclosure, halftone levels are used to select different types of masks, as discussed below.

The printer 100 includes a storage medium 108 that can store information relating to different types of masks 110. The storage medium 108 can be implemented with a collection of storage devices (a single storage device or multiple storage devices). Examples of storage devices can include any or some combination of the following: a disk-based storage device, a solid-state drive (SSD), a memory device, and so forth.

The color separation engine 106 includes a mask selection logic 112 that is able to selectively use different types of masks for printing an image according to the image data 104 received by the printing pipeline 102. The mask selection logic 112 can be implemented using a portion of the hardware processing circuitry of the color separation engine 106, or alternatively, can be implemented using machine-readable instructions executable by the color separation engine 106.

In some examples, the color separation engine 106 generates input NPac vectors from the image data 104. The input NPac vectors can be produced using a lookup table (LUT) 114 stored in the storage medium 108.

Based on each input NPac vector, the mask selection logic 112 selects different types of masks to use when dispensing printing fluid drops of each given colorant when printing an image according to the image data 104. Based on the different types of masks selected, the color separation engine 106 produces output NPac vectors. The output NPac vectors produced by the color separation engine 106 are included in output NPac data 116 that is provided by the color separation engine 106 to a halftoning engine 118 in the printing pipeline 102.

The halftoning engine 118 applies a halftoning process to reproduce a continuous tone image (as represented by the image data 104 in the image color space) in a colorant color space using a series of shapes (e.g., dots). This enables the printer 100 to approximate a continuous tone image by using a discrete number of colorants (e.g., a discrete number of printing fluid drops).

A colorant may be a print material, e.g., ink, toner, fluid, varnish, etc. The colorant may be defined with reference to a color space. A printed image printed using a halftoning process may appear continuous from a distance, e.g., colors blend into each other. However, when inspected at close range, the printed image is found to be constructed from layers of colorant with discrete deposit patterns. The result of this process is an output in the form of a color separated halftone including a halftone plane corresponding to each colorant available to the printing system.

The halftoning engine 118 distributes the proportions of each output NPac vector in the output NPac data 116. For each pixel in the halftone, the halftoning engine 118 selects a single NP from the NPs in the respective output NPac vector (note that each pixel is associated with a corresponding NPac vector), based on the distribution of probabilities defined in the respective output NPac vector for the NPs. The halftoning engine 118 generates the control data 120 based on the selected NPs.

The control data 120 is used by the controller 101 to control printing operations to print the image according to the image data 104. The printing operations can include advancing the print medium 134 in a print medium advance direction 122, as well as moving the printhead 130 along a direction 124 in each pass of the printhead 130. The printhead 130 may be mounted on a carriage that can be moved under control of the storage controller.

The printer 100 employs multiple passes when printing an image. With multi-pass printing, each pixel of the image to be printed is subject to receiving ejected printing fluids multiple times in the respective multiple passes, depending on actuation of nozzles according to the image data 104.

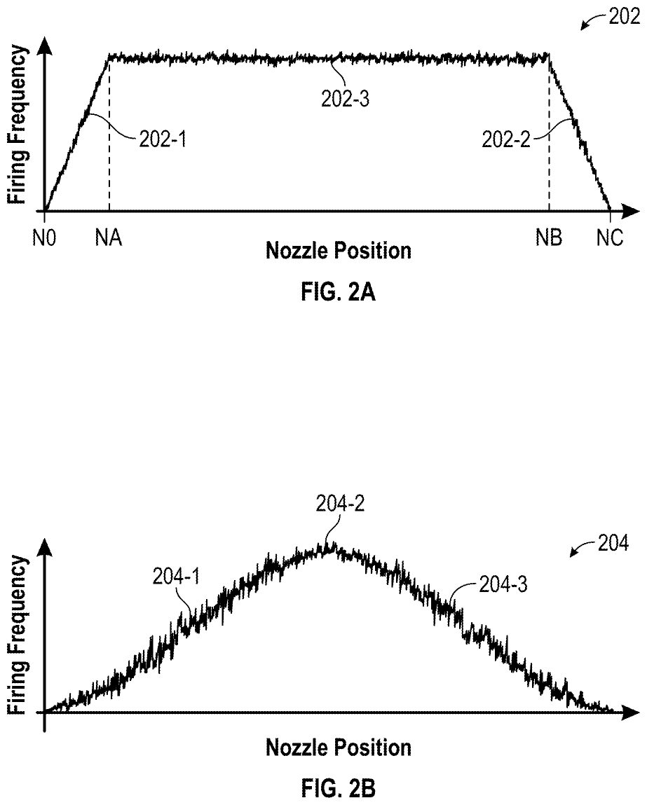

FIGS. 2A-2B show two different types of masks that can be employed by the printing pipeline 102, according to some examples. FIG. 2A shows a trapezoid mask 202, and FIG. 2B shows a square sine mask 204.

In each of FIGS. 2A and 2B, the horizontal axis represents nozzle position on the printhead 130 along an axis 136 as shown in FIG. 1. The vertical axis of each graph depicted in each of FIGS. 2A and 2B represent a firing frequency of nozzles (a number of times the nozzles are actuated per unit time).

The trapezoid mask 202 of FIG. 2A has sharper features with ramps 202-1 and 202-2 at the beginning and end, respectively, that rise and fall at relatively sharp slopes. The ramp 202-1 indicates that the firing frequency of nozzles increases with nozzle position from left to right between nozzle position NO and nozzle position NA in the view of FIG. 2A. The ramp 202-2 indicates that the firing frequency of nozzles decreases with nozzle position from left to right between nozzle position NB and nozzle position NC.

A relatively center flat portion 202-3 (between the ramps 202-1 and 202-2) of the trapezoid mask 202 indicates that a relatively constant firing frequency is used at the nozzle positions starting at nozzle position NA and ending at nozzle position NB.

The square sine mask 204 of FIG. 2B has smoother profile than the trapezoid mask 202. When the square sine mask 204 is used, the firing frequency gradual increases with nozzle position in rising section 204-1 until the firing frequency reaches an apex 204-2, followed by a gradual reduction in the firing frequency with nozzle position in a falling section 204-3.

Use of the square sine mask 204 would provide a smoother pass-to-pass interaction of drops on each pixel from multiple passes than use of the trapezoid mask 202. However, the use of the square sine mask is subject to other constraints, including a reduced firing frequency that may not be suitable for printing high-density colors. Use of the trapezoid mask 202 with sharper boundaries can allow for higher frequency of nozzle firings to support high-density color regions, but use of the trapezoid mask 202 may lead to banding issues in the image printed by the printer 100.

Although FIG. 2A-2B show two example types of masks that can be employed, in further examples, additional or alternative masks can be employed by the printing pipeline 102.

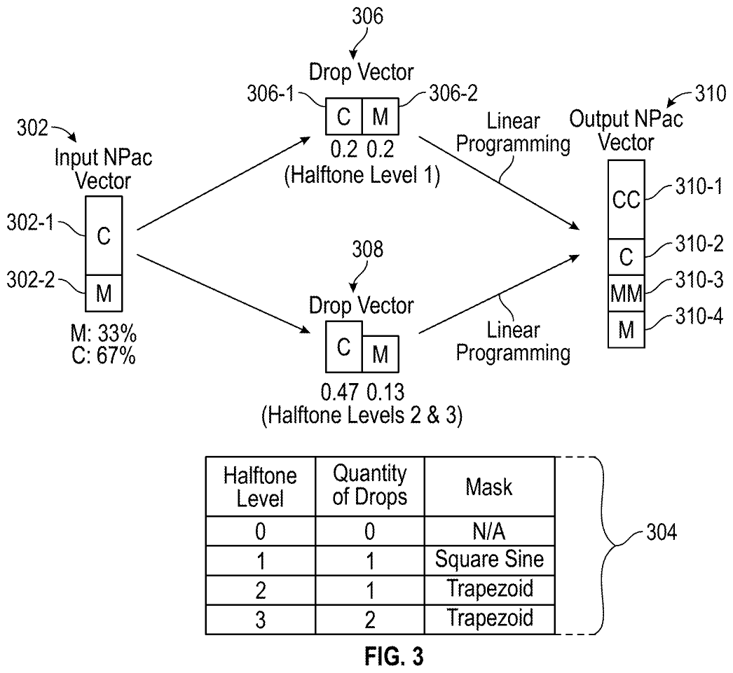

FIG. 3 shows an example of a process performed by the color separation engine 106, in accordance with some examples of the present disclosure. In FIG. 3, an input NPac vector 302 is depicted, which has two NPs 302-1 and 302-2. For purposes of simplicity, simple NPac vectors are depicted. In actual use, an NPac vector can include a larger quantity of NPs.

The input NPac vector 302 defines a 33% probability for the NP 302-1, and a 67% probability for the NP 302-2. The NP 302-1 uses the C colorant, and the NP 302-2 uses the M colorant. In other examples, an NP of an NPac vector can select use of multiple colorants.

In accordance with some implementations of the present disclosure, halftone levels are used in the selection of different masks as performed by the mask selection logic 112 in the color separation engine 106. An example mapping information 304 (e.g., a mapping table) maps halftone levels to different types of masks is shown in FIG. 3. The mapping information 304 can be stored in a storage medium, such as the storage medium 108 of FIG. 1.

The mapping information 304 maps different halftone levels (e.g., halftone level 0, halftone level 1, halftone level 2, halftone level 3) to corresponding different types of masks as well as to corresponding quantities of printing fluid drops to be dispensed from each nozzle in a pass. The quantity of drops dispensed from a nozzle in a fluid injection operation provides a drop weight from the nozzle. In the example of FIG. 3, the possible quantities of drops include 0, 1, and 2.

The example of FIG. 3 assumes that two bits per pixel are used to represent halftone levels. In other examples, more halftone levels can be represented with use of a larger number of bits per pixel.

Typically, halftone levels are used to represent the quantities of drops that should be dispensed onto a given pixel from a nozzle. However, in accordance with some implementations of the present disclosure, halftone levels are used to map to different mask selections, as well as to quantities of drops to employ. According to the mapping information 304, if the halftone level is 0, then no mask is selected and the quantity of drops used is 0. A halftone level 1 maps to use of the square sine mask, and 1 drop. Halftone level 2 maps to use of the trapezoid mask, and 1 drop. Halftone level 3 maps to use of the trapezoid mask, and 2 drops.

A mask has different layers that have information on when to fire drops, up to a maximum of 3 drops for the printing pipeline 102 that uses 2 bits per pixel. Using halftone level selection by the mask selection logic 112 to select different types of masks, the color separation engine 106 can ensure that layer 1 of a mask is not fired at the same time as layers 2 and 3 of the mask, to allow independent use of each mask of the different types of masks. This means that when layer 2 or 3 (corresponding to halftone level 2 or 3, respectively) of a mask is activated to fire 1 or 2 drops, respectively, layer 1 (corresponding to halftone level 1) of the mask is inactive (and vice versa).

As shown in FIG. 3, a halftone level distribution generated by the mask selection logic 112 based on the input NPac vector 302 divides a printing fluid quantity that is to be dispensed onto a pixel into a first printing fluid sub-quantity and a second printing fluid sub-quantity. The first printing fluid sub-quantity can be considered a budget (or threshold) amount of a printing fluid of a colorant (e.g., the M colorant or C colorant of FIG. 3) for which a smoother mask (e.g., the square sine mask) is to be employed.

In the example of FIG. 3, the budget (or threshold) amount of a printing fluid of a colorant is 0.2 drops. For any printing fluid quantity of a given colorant that is to be dispensed, the first 0.2 drops of the given colorant is mapped to halftone level 1, which correlates to the square sine mask in the mapping information 304. Any printing fluid above 0.2 drops for the given colorant is mapped to halftone levels 2 and 3, which correlates to the trapezoid mask in the mapping information 304.

In other examples, budgets (thresholds) different from 0.2 drops can be employed.

By dividing a printing fluid quantity of a colorant into different portions that employ different types of masks, each colorant can benefit from using a smoother mask for the first printing fluid sub-quantity while also benefiting from using another mask (e.g., the trapezoid mask) that is more suitable for high-density printing for the second printing fluid sub-quantity. Although the example given divides a printing fluid quantity into two sub-quantities that map to two different types of masks, it is noted that in other examples, a printing fluid quantity can be divided into more than two sub-quantities that map to more than two different types of masks.

In FIG. 3, based on the input NPac vector 302, a first drop vector 306 and a second drop vector 308 are derived. A “drop vector” can also be referred to as an “ink vector,” and the drop vector represents a quantity of a printing fluid of each colorant that is to be dispensed according to the drop vector.

More specifically, the mask selection logic 112 can convert the input NPac vector 302 to a drop vector, and the drop vector can be split into the first drop vector 306 and the second drop vector 308.

The drop vector 306 includes a first element 306-1 corresponding to the C colorant, and a second element 306-2 corresponding to the M colorant. The drop vector 306 specifies that 0.2 drops of each of the C and M colorants are associated with halftone level 1.

The drop vector 308 includes a first element 308-1 corresponding to the C colorant, and a second element 308-2 corresponding to the M colorant. The first element 308-1 specifies 0.47 drops of the C colorant, and the second element 308-2 specifies 0.13 drops of the M colorant. The drop vector 308 is associated with halftone levels 2 and 3. The 0.47 value for the C colorant is derived by taking the difference between 0.67 (the 67% value for the C colorant specified by the input NPac vector 302) and 0.2, and the 0.13 value for the M colorant is derived by taking the difference between 0.33 (the 33% value for the M colorant specified by the input NPac vector 302) and 0.2.

Effectively, the mask selection logic 112 of the color separation engine 106 maps a first printing fluid sub-quantity (0.2 drops) of each colorant to halftone level 1 (that corresponds to the square sine mask), and maps a second printing fluid sub-quantity (above 0.2 drops) of each colorant to halftone levels 2 and 3 (that correspond to the trapezoid mask).

The color separation engine 106 allocates an area coverage to each drop vector 306 and 308 proportional to the total printing fluid volume, adding up to 100% of the total printing fluid volume. An NPac vector is a description of statistics of pixel states (or equivalently NPs), and therefore the area coverages have to add up to 100%. The color separation engine 106 reserves some of that area coverage for each NPac vector, with both area coverages adding up to 100%. By splitting into the two drop vectors 306 and 308, effectively two NPac vectors are built based on the two drop vectors 306 and 308, respectively, and the two NPac vectors are joined together to produce an output NPac vector 310.

As further shown in FIG. 3, linear programming can be applied to generate the output NPac vector 310 based on the drop vectors 306 and 308. Linear programming is a numerical method for solving systems of linear equations with constraints. Since an infinite number of NPac vectors can be produced for any given drop vector, the use of linear programming allows the color separation engine 106 to place a constraint on the possible NPac vectors that can be output, by assigning weights to NPs based on preference or priorities of the NPs. Each drop vector 306 and 308 causes a respective NPac vector to be produced, and the two NPac vectors are joined to form the output NPac vector 310.

The output NPac vector 310 includes four NPs 310-1, 310-2, 310-3, and 310-4. The NP 310-1 selects two drops of the C colorant, the NP 310-2 selects one drop of the C colorant, the NP 310-3 selects two drops of the M colorant, and the NP 310-4 selects one drop of the M colorant. The output NPac vector 310 defines the following probabilities for the NPs: 20% for the NP 310-1, 13% for the NP 310-2, 20% for the NP 310-3, and 47% for the NP 310-4. The output NPac vector 310 can encode use of the square sine mask for NPs 310-2 and 310-4, and can encode use of the trapezoid mask for NPs 310-1 and 310-3.

The example of FIG. 3 uses a printing fluid budget that is set per colorant. In other examples, a printing fluid budget can be set as varying per-contone or globally. For example, different budgets (thresholds) can be set for each of the different colorants and/or for different input image data (different contones).

In accordance with some implementations of the present disclosure, techniques or mechanisms are provided to introduce the ability to arbitrarily assign different mask types to each halftone level (or NP). The specific mask shapes (e.g. trapezoid, square sine, or others), when and how to assign different masks (based on printing fluid amount, contone, NP, or via any other attribute that relates to the contents of image data) as well as how to introduce a split in the NPac vectors can be varied and parametrized, with some constraints (e.g., masks have to be complementary, NPac vectors should keep printing fluid amounts to ensure that the NPac building process does not alter the printing fluid quantity to dispense, etc.). Masks being complementary means that two masks are made in a way that the two masks do not collide with each other, to avoid the case where a nozzle is to fire twice in the same position and time.

Different types of masks can be selected for different contones (e.g., different input CMYK or RGB image data).

Different types of masks can be selected for different NPs. An NP is a possible pixel state, including a combination of halftone levels from all the possible colorants. For example, it may be desired to do something different when cyan and magenta coincide in the same pixel. In that case, the mask selection logic 112 can identify the NPs that match that condition (CM, CMM, CCM, etc.), and encode the NPs to apply a different mask.

Techniques or mechanisms according to some examples can employ a set of different types of masks that reduce banding in different colors, and a strategy on how to use the different types of masks. The printing pipeline 102 enables arbitrary addressing of such masks on an input color basis, in some examples. The amount of printing fluid reserved for each mask can be configurable for each colorant and for each input color. The control of how colors using different printing amounts are distributed along printing passes, can allow for smooth, gradual masks for lower densities complemented with more traditional shaped masks for higher densities, resulting in overall reduced image quality artifacts, including banding.

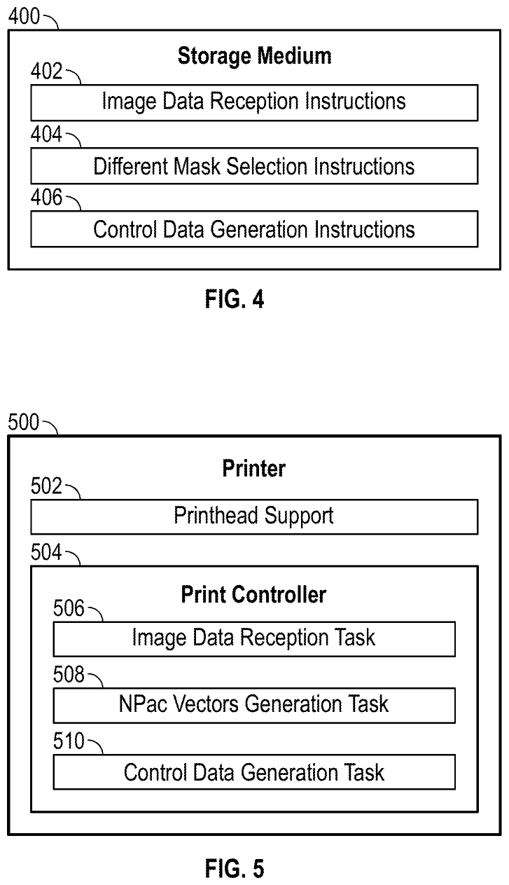

FIG. 4 is a block diagram of a non-transitory machine-readable or computer-readable storage medium 400 storing machine-readable instructions that upon execution cause a system to perform various tasks. The storage medium 400 can be part of the printer 100 of FIG. 1, for example, or part of a computer separate from the printer 100.

The machine-readable instructions include image data reception instructions 402 to receive image data (e.g., 104 in FIG. 1) for printing by a printer.

The machine-readable instructions include different mask selection instructions 404 to, for a given colorant of a plurality of colorants to be used to print an image based on the image data, select a plurality of different types of masks to use when dispensing printing fluid drops of the given colorant when printing the image, the plurality of different types of masks including a first type of mask for printing fluid drops having a first relationship with respect to an attribute (e.g., the attribute is printing fluid amount) relating to a content of the image data, and a second type of mask for printing fluid drops having a different second relationship with respect to the attribute relating to the content of the image data. As an example, as shown in FIG. 3, a first sub-quantity of the printing fluid uses the first type of mask, and a second sub-quantity of the printing fluid above a budget uses the second type of mask. In other examples, the attribute can be a contone, an NP, and so forth, and different masks can be selected based on the attribute.

The machine-readable instructions include control data generation instructions 406 generate control data (e.g., 120 in FIG. 1) for printing the image using the selected plurality of different types of masks.

In some examples, selecting of the plurality of different types of masks includes selecting the first type of mask for an amount of printing fluid drops under a drop amount threshold, and selecting the second type of mask for an amount of printing fluid drops over the drop amount threshold.

In some examples, generating the control data employs halftoning, and the system to associates a first halftone level with the printing fluid drops having the first relationship with respect to the attribute, and associates a second halftone level with the printing fluid drops having the second relationship with respect to the attribute, where different halftone levels correspond to respective different types of masks of the plurality of different types of masks.

In some examples, the system converts the image data in a first color space to NPac vectors in an NPac color space, and splits an NPac vector of the NPac vectors into a plurality of drop vectors (or ink vectors) (e.g., 306 and 308 in FIG. 3) that map to the different halftone levels.

In some examples, the system generates an output NPac vector (e.g., 310 in FIG. 3) based on the plurality of drop vectors, where the output NPac vector includes a plurality of NPs, and where NPs corresponding to a first drop vector of the plurality of drop vectors use the first halftone level, and NPs corresponding to a second drop vector of the plurality of drop vectors use the second halftone level.

In some examples, the system allocates a respective area coverage to each drop vector of the plurality of drop vectors, where the respective area coverage proportional to an overall printing fluid volume. Each drop vector of the plurality of drop vectors can represent amounts of printing fluid drops of respective colorants of the plurality of colorants.

In some examples, the first type of mask (e.g., the square sine mask) has a smoother ramp as a function of nozzle position of a printhead than the second type of mask (e.g., the trapezoid mask).

FIG. 5 is a block diagram of a printer 500 according to some examples. The printer 500 includes a printhead support 502 (e.g., a carriage, a printbar, a cartridge, etc.) to receive a printhead.

The printer 500 includes a print controller 504 to perform various tasks. The tasks of the print controller 504 include an image data reception task 506 to receive image data for printing by the printer 500.

The tasks of the print controller 504 include an NPac vectors generation task 508 to generate, based on the image data, NPac vectors (e.g., including the output NPac vector 310 of FIG. 3) in an NPac color space, where each NPac vector of the NPac vectors includes NPs that map to use of different types of masks.

The tasks of the print controller 504 include includes a control data generation task 510 to generate control data for printing the image using the different types of masks.

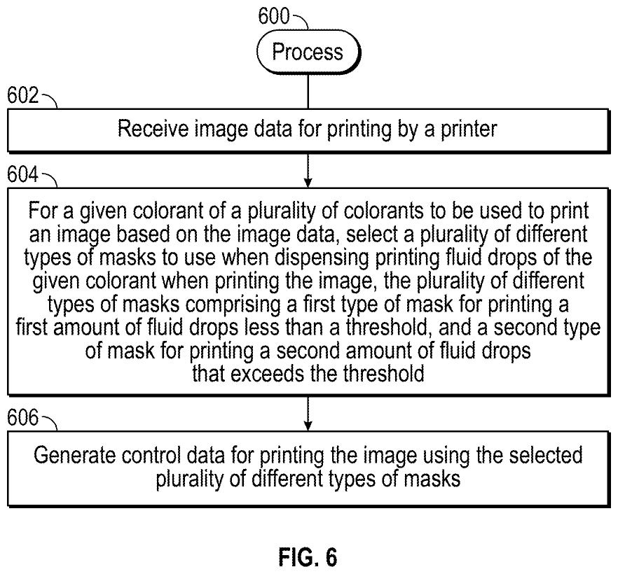

FIG. 6 is a flow diagram of a process 600 according to some examples. The process 600 can be performed by a printing pipeline (e.g., 102 in FIG. 1), for example.

The process 600 includes receiving (at 602) image data for printing by a printer.

The process 600 includes, for a given colorant of a plurality of colorants to be used to print an image based on the image data, selecting (at 604) a plurality of different types of masks to use when dispensing printing fluid drops of the given colorant when printing the image, the plurality of different types of masks comprising a first type of mask for printing a first amount of fluid drops less than a threshold, and a second type of mask for printing a second amount of fluid drops that exceeds the threshold.

The process 600 includes generating (at 606) control data for printing the image using the selected plurality of different types of masks.

A storage medium (e.g., 400 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive image data for printing by a printer;
for a given colorant of a plurality of colorants to be used to print an image based on the image data, select a plurality of different types of masks to use when dispensing printing fluid drops of the given colorant when printing the image, the plurality of different types of masks comprising a first type of mask for printing fluid drops having a first relationship with respect to an attribute relating to a content of the image data, and a second type of mask for printing fluid drops having a different second relationship with respect to the attribute relating to the content of the image data; and
generate control data for printing the image using the selected plurality of different types of masks.

2. The non-transitory machine-readable storage medium of claim 1, wherein the selecting of the plurality of different types of masks comprises:
selecting the first type of mask for an amount of printing fluid drops under a drop amount threshold, and
selecting the second type of mask for an amount of printing fluid drops over the drop amount threshold.

3. The non-transitory machine-readable storage medium of claim 1, wherein generating the control data employs halftoning, and wherein the instructions upon execution cause the system to:
associate a first halftone level with the printing fluid drops having the first relationship with respect to the attribute; and
associate a second halftone level with the printing fluid drops having the second relationship with respect to the attribute,
wherein different halftone levels correspond to respective different types of masks of the plurality of different types of masks.

4. The non-transitory machine-readable storage medium of claim 3, wherein the instructions upon execution cause the system to:
convert the image data in a first color space to Neugebauer Primary area coverage (NPac) vectors in an NPac color space; and
split a first NPac vector of the NPac vectors into a plurality of drop vectors that map to the different halftone levels.

5. The non-transitory machine-readable storage medium of claim 4, wherein the instructions upon execution cause the system to:
generate an output NPac vector based on the plurality of drop vectors, wherein the output NPac vector comprises a plurality of Neugebauer Primaries (NPs), wherein NPs corresponding to a first drop vector of the plurality of drop vectors use the first halftone level, and NPs corresponding to a second drop vector of the plurality of drop vectors use the second halftone level.

6. The non-transitory machine-readable storage medium of claim 5, wherein the instructions upon execution cause the system to:
allocate a respective area coverage to each drop vector of the plurality of drop vectors, the respective area coverage proportional to an overall printing fluid volume.

7. The non-transitory machine-readable storage medium of claim 4, wherein each drop vector of the plurality of drop vectors represents amounts of printing fluid drops of respective colorants of the plurality of colorants.

8. The non-transitory machine-readable storage medium of claim 3, wherein the first halftone level corresponds to use of a first quantity of printing fluid drops per pixel, and the second halftone level corresponds to use of a different second quantity of printing fluid drops per pixel.

9. The non-transitory machine-readable storage medium of claim 3, wherein the first halftone level corresponds to use of a first quantity of printing fluid drops per pixel, and the second halftone level corresponds to use of the first quantity of printing fluid drops per pixel.

10. The non-transitory machine-readable storage medium of claim 3, wherein the selecting of the plurality of different types of masks and the generating of the control data are performed in a Halftone Area Neugebauer Separation (HANS) pipeline.

11. The non-transitory machine-readable storage medium of claim 1, wherein the first type of mask has a smoother ramp as a function of nozzle position of a printhead than the second type of mask.

12. A printer comprising:
a support to receive a printhead; and
a print controller to:
receive image data for printing by the printer;
generate, based on the image data, Neugebauer Primary area coverage (NPac) vectors in an NPac color space, wherein each NPac vector of the NPac vectors comprises Neugebauer Primaries (NPs) that map to use of different types of masks; and
generate control data for printing an image using the different types of masks.

13. The printer of claim 12, wherein the NPs of each NPac vector map to different halftone levels that are associated with use of the different types of masks.

14. A method of a system comprising a hardware processor, comprising:
receiving image data for printing by a printer;
for a given colorant of a plurality of colorants to be used to print an image based on the image data, selecting a plurality of different types of masks to use when dispensing printing fluid drops of the given colorant when printing the image, the plurality of different types of masks comprising a first type of mask for printing a first amount of fluid drops less than a threshold, and a second type of mask for printing a second amount of fluid drops that exceeds the threshold; and
generating control data for printing the image using the selected plurality of different types of masks.

15. The method of claim 14, further comprising:
mapping different halftone levels to different types of masks of the plurality of different types of masks;
associating a first halftone level of the different halftone levels with the first amount of printing fluid drops less than the threshold; and
associating a second halftone level of the different halftone levels with the second amount of printing fluid drops that exceeds the threshold.
